(19) United States
(12) Patent Application Publication
(10) Pub. No.: US 2022/0417109 A1
(43) Pub. Date: Dec. 29, 2022

(54) METHODS FOR DETERMINING APPLICATION OF MODELS IN MULTI-VENDOR NETWORKS

(71) Applicant: Telefonaktiebolaget LM Ericsson (publ), Stockholm (SE)

(72) Inventors: Aneta VULGARAKIS FELJAN, STOCKHOLM (SE); Lackis ELEFTHERIADIS, VALBO (SE); Leonid MOKRUSHIN, UPPSALA (SE); Marin ORLIC, BROMMA (SE)

(21) Appl. No.: 17/780,312

(22) PCT Filed: Nov. 28, 2019
(86) PCT No.: PCT/SE2019/051204

§ 371 Date: May 26, 2022

(51) Int. Cl. H04L 41/16; H04L 41/12; G06N 20/20

(52) U.S. Cl. CPC H04L 41/16; H04L 41/12; G06N 20/20

(57) ABSTRACT

A method performed by network node for determining application of at least one machine learning model from a plurality of machine learning models in a multi-vendor communications network is provided. The network node can receive a request from an actor device operating in a target network to enable running a task for the target network by using a machine learning models from the plurality of machine learning models to perform the task. Responsive to the request, the network node can determine whether a machine learning model from the plurality of machine learning models can perform the task or can be translated to perform the task. Responsive to the determination, the network node can send a communication to the actor device. The communication can include information that a machine learning model is ready to perform the task or that no machine learning model was found to perform the task.

### TECHNICAL FIELD

The present disclosure relates generally to determining application of machine learning models in a multi-vendor communications network.

### BACKGROUND

Each operator network is different in topology, vendor equipment used and configuration parameters. When a machine learning (ML) model is created implementing a task such as a prediction, optimization, or classification task, the ML model needs to be trained and adapted to each deployment to achieve enough accuracy.

The following explanation of potential problems is a present realization as part of the present disclosure and is not to be construed as previously known by others. Assuming a collection of trained ML models is available for a specific task(s) in an operator network, the collection of trained ML models may not be suitable for use in the operator's network. Another problem may be how to select the applicable ML model(s) from a collection of existing ML models. Thus, improved or optimized methods for selection of an existing ML model in multi-vendor networks is desirable.

### SUMMARY

According to some embodiments, a method performed by a first network node for determining application of at least one machine learning model from a plurality of machine learning models in a multi-vendor communications network is provided. The first network node can receive a request from an actor device operating in a target network to enable running a task for the target network on the communications network by using at least one of the machine learning models from the plurality of machine learning models to perform the task. Responsive to the request, the first network node can determine whether at least one of the machine learning models from the plurality of machine learning models can perform the task or can be translated to perform the task. Responsive to the determination, the first network node can send a communication to the actor device. The communication can include information that a machine learning model from the plurality of machine learning models is ready to perform the task or that no machine learning model was found to perform the task.

According to some embodiments, a first network node configured to operate in a communication network is provided. The first network node can include at least one processor. The first network node can further include a memory coupled with the least one processor, wherein the memory includes instructions that when executed by the at least one processor causes the at least one processor to perform operations. The operations can include receiving a request from an actor device operating in a target network to enable running a task for the target network on the communications network by using at least one of the machine learning models from the plurality of machine learning models to perform the task. Responsive to the request, the operations can further include determining whether at least one of the machine learning models from the plurality of machine learning models can perform the task or can be translated to perform the task. Responsive to the determination, the operations can further include sending a communication to the actor device. The communication can include information that a machine learning model from the plurality of machine learning models is ready to perform the task or that no machine learning model was found to perform the task.

According to some embodiments, a computer program can be provided that includes instructions which, when executed on at least one processor, cause the at least one processor to carry out methods performed by the first network node.

According to some embodiments, a computer program product can be provided that includes a non-transitory computer readable medium storing instructions that, when executed on at least one processor, cause the at least one processor to carry out methods performed by the first network node.

Other systems, computer program products, and methods according to embodiments will be or become apparent to one with skill in the art upon review of the following drawings and detailed description. It is intended that all such additional systems, computer program products, and methods be included within this description and protected by the accompanying claims.

Operational advantages that may be provided by one or more embodiments may include providing reuse of existing ML models to predict key performance indicators (KPIs), outages, monitoring service-level agreement (SLA) etc. A further advantage may provide taking advantage of similarities of networks without the need to obtain training data by reusing the same ML model. Further potential advantages may provide reducing time to deployment of a ML model(s), improving latency, reducing downtime, and reducing the energy impact of training a ML model, which may be significant.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates an exemplary multi-vendor communications network in accordance with some embodiments of the present disclosure;

FIG. 2 illustrates an example of a sequence of operations that can be performed by a network node for determining application and reuse of at least one machine learning model in a multi-vendor communications network in accordance with some embodiments of the present disclosure;

FIG. 3 illustrates an example of a sequence of operations that can be performed by a first network node running a deployed machine learning model according to some embodiments of the present disclosure;

FIG. 4 is a block diagram illustrating a selector and adaptor node (also referred to as a first network node) according to some embodiments of the present disclosure;

FIG. 5 is a block diagram of a network control node (also referred to as a third network node) according to some embodiments of the present disclosure;

FIG. 6 is a block diagram of a conversion node (also referred to as a second network node) according to some embodiments of the present disclosure;

FIG. 7 is a block diagram of a ML model database (also referred to as a second database) according to some embodiments of the present disclosure;

FIG. 8 is a block diagram of a network inventory database (also referred to as a first database) according to some embodiments of the present disclosure;

FIG. 9 is a block diagram of a network database (also referred to as a third database) according to some embodiments of the present disclosure;

FIG. 10 is a block diagram of an actor device according to some embodiments of the present disclosure;

FIGS. 11-16 are flowcharts illustrating operations that may be performed by a network node in accordance with some embodiments of the present disclosure; and

FIG. 17 is a block diagram of a virtualization environment in accordance with some embodiments of the present disclosure.

### DETAILED DESCRIPTION

Various embodiments will be described more fully hereinafter with reference to the accompanying drawings. Other embodiments may take many different forms and should not be construed as limited to the embodiments set forth herein; rather, these embodiments are provided by way of example to convey the scope of the subject matter to those skilled in the art. Like numbers refer to like elements throughout the detailed description.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

When a machine learning (ML) model is created implementing a task such as a prediction, optimization or classification task, the ML model needs to be trained and adapted to each deployment to achieve enough accuracy. Problems may exist where an operator network is different in topology, vendor equipment used and/or configuration parameters than a collection of trained models based on different topologies, vendor equipment and/or configuration parameters available for performing a task(s) in the operator network. The collection of trained ML models may not be suitable for use in the operator network having a different topology, different vendor equipment used and/or different configuration parameters. In some approaches, a ML model may have to be trained for the operator network having the different topology, vendor equipment, and/or configuration parameters. Training of a ML model, however, is time consuming; and a ML model should not be deployed into a live network until the ML is sufficiently trained. Moreover, training a ML model may have a significant energy impact. See e.g., “Training a single AI model can emit as much carbon as five care in their lifetimes.” MIT Technology Review, https://www.technologyreview.com/s/613630/training-a-single-ai-model-can-emit-as-much-carbon-as-five-cars-in-their-lifetimes/.

Another problem may be how to select an applicable ML model(s) from a collection of existing ML models for a new situation based on the similarity of the new situation to the training situation. As ML models increase in number and complexity, a manual approach may not be possible.

In some approaches for selecting an existing ML model for use in an operator network having a different topology, different vendor equipment, different configuration parameters, and/or a new situation, inputs (features) to an existing ML model(s) may be converted based on similarity of the content of the data between the different vendors. The conversion may be based on syntactic similarity between the values. Such an approach, however, may not solve problems of data that describes the same physical process, but the ML model(s) used are not completely similar.

Certain aspects of the present disclosure and their embodiments may provide solutions to these and/or other challenges.

In various embodiments, at least one ML model may be adapted and data for a target network converted based on the semantic mapping of the data. Applicable ML models may be selected using a complex set of criteria derived for each situation and may solve problems when the equipment between different vendors produces data that does not look alike.

For example, in various embodiments, selecting and applying a ML model that was trained on data for equipment from vendor A to a network using equipment from vendor B, may enable reuse of an existing ML model(s) in different situations. The selection and adaptation of ML models may be guided by semantic similarity as each ML model may be described according to an ontology. An ontology may provide, e.g., a set of data for each ML model and its relation to other data (described further herein).

Presently disclosed embodiments may provide potential advantages. One potential advantage may provide reuse of existing ML models to predict KPIs, outages, monitor SLA, etc. Another potential advantage may provide reducing ML model training time by reusing findings across network providers, countries, regions, etc. A further potential advantage may provide taking advantage of similarities of networks without the need to obtain training data by reusing the same ML model (e.g., two operators in the same city with similar network patterns, density, etc. but different equipment can reuse the same ML model(s)). Another potential advantage may provide reducing time to deployment of a ML model(s). A further potential advantage may provide improved latency and reduced downtime of a ML model(s) based on reusing an existing ML model. Another potential advantage may provide reducing the energy impact of training a ML model, which may be significant.

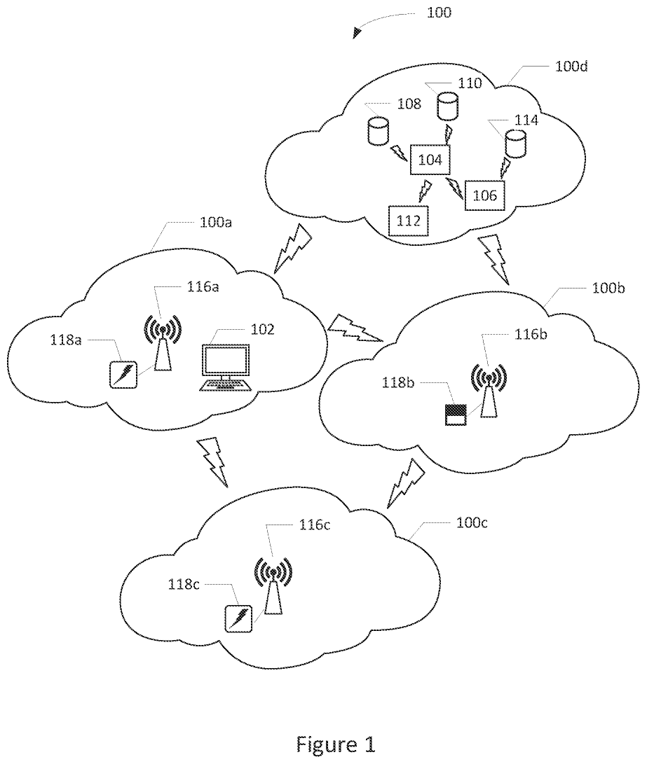

FIG. 1 illustrates an exemplary multi-vendor communications network 100 in accordance with various embodiments of the present disclosure. As shown in FIG. 1, multi-vendor communications network 100 includes networks 100a, 100b, 110c, and 100d. Each network 100a, 100b, and 100c may include network equipment from different vendors, e.g., base stations 116a, 116b, and 116c and power supplies 118a, 118b, and 118c. For example, power supplies 118a and 118c may be diesel power supplies, and power supply 118b may be a solar power supply. The exemplary power supplies 118 may include any type of power supply (e.g., diesel, solar, electric grid, battery, etc.).

Exemplary multi-vendor communications network 100 may include an actor device 102 (also referred to herein as a client device 102 or a wireless device 102) that makes a request (as described further herein) for a prediction, a proposal, a probability, an action, an optimization, a classification, or other analytical task, etc. (“task”) on the network 100.

Network 100d may include a network node 104 for determining application and reuse of at least one machine learning model from a plurality of machine learning models in multi-vendor communications network 100. Network node 104 may be referred to herein as a selector and adaptor node 104 as an exemplary description and this exemplary description is not intended to suggest any limitation as to the scope of use or functionality of network node 104. Selector and adaptor node 104 may operate to receive a request from an actor device 102 to enable running a task on a target network 100a by adapting network data for target network 100a to an existing ML model(s) that can perform the requested task on target network 100a. Selector and adaptor node 104 may look for applicable ML models in database 108 and construct an adaption of the network data using a conversion function. The network data may be stored in database 114.

Network 100d also may include network node 106 for managing and running a ML model(s) selected and/or adapted by selector and adaptor node 104. Network node 106 may be referred to herein as a network control node 106 as an exemplary description and this exemplary description is not intended to suggest any limitation as to the scope of use or functionality of network node 106. Database 108 may contain ML models and corresponding descriptors of purpose for each ML model (e.g., KPIs to maintain), situations where to apply each ML model (e.g., network topology and equipment that is fit for use of each ML model), and inputs/outputs (e.g. performance metrics (PM) counters to use as inputs to each ML model). Database 108 may be referred to herein as a ML model database 108 as an exemplary description and this exemplary description is not intended to suggest any limitation as to the scope of use or functionality of database 108.

Still referring to FIG. 1, network 100d also may include database 110 which may contain a description of each operator's network (e.g., networks 100a, 100b, 100c, etc.). The description may be a network inventory model according to a network ontology. The network inventory model may include a matching of the equipment (e.g., base station 116a and diesel energy source 118a) in each network (e.g., network 100a) to a ML model that has been trained for that equipment. For example, if a ML model has been trained on a network node trained for three uplinks, the ML model is not matched to another network node that provides only two uplinks (and therefore should not be used the other network node). In a further example, if a ML model has been trained on network equipment with a diesel power supply, the ML model is not matched to network equipment that is powered on solar supply (and therefore should not be used for network equipment that is powered with a solar supply). Database 110 may be referred to herein as a network inventory database 110 as an exemplary description and this exemplary description is not intended to suggest any limitation as to the scope of use or functionality of database 110.

Network 100d may further include network node 112 containing conversion functions that can be used to convert or adapt inputs and/or outputs to a ML model(s). Conversion or adaption of inputs and/or outputs to a ML model(s) may be done using network data for a target network and rules for conversion in a symbolic form. Network data may include metadata or data for network equipment (e.g., base station 116a and diesel power supply 118a) for determining whether a ML model may be used, or adapted for use, for by other network equipment (e.g., base station 116b and solar power supply 118b) or in other situations (e.g., a network node with two uplinks versus three uplinks). Conversion includes, for example, looking up the meaning of the inputs and/or outputs to a ML model(s) in an ontology and matching the related concepts. Network node 112 may be referred to herein as a conversion node 112 as an exemplary description and this exemplary description is not intended to suggest any limitation as to the scope of use or functionality of network node 112.

Examples of a conversion function include the following.

In one example, a unit of measurement is transformed from one unit to another. For example, if equipment (e.g., diesel power supply 118a) located in a network (e.g., network 100a) provides temperature in Celsius (C) and an existing ML model expects the data to be in Fahrenheit (F), then the temperature data of the equipment (e.g., diesel power supply 118a) needs to be transformed to F according to a conversion function from C to F.

In another example, low-level counters to PM counters are converted to KPI(s). The KPI(s) may be vendor- and/or deployment-specific, depending on the structure and configuration of a network.

In a further example, one type of data is mapped as being identical to another type of data, such as counter names For example, datacenter hardware Intelligent Platform Management Interface (IPMI) counters having different names may be mapped as being identical, e.g., a datacenter IPMI counter named “02-CPU_1Sys1(Temperature)[° C]” may be mapped as being identical to a datacenter IPMI named “TempSys1(Temperature)M”; and a datacenter IPMI counter named “Voltage_2Sys2(Voltage)[VV]” may be mapped as being identical to a datacenter IPMI counter named “ACDC_VINDev97(Voltage)[V]”, etc.

In another example, various vendors may have similar, but not identical, network PM counters. An exemplary conversion function may calculate KPIs from the raw counter values.

Still referring to FIG. 1, network 100d also may include database 114 which may contain network data for a target network (e.g., 100a) that may be provided as inputs to a selected or adapted ML model (as further described herein). Database 114 may be referred to herein as a network database 114 as an exemplary description and this exemplary description is not intended to suggest any limitation as to the scope of use or functionality of database 114.

While network 100a is illustrated as a telecommunications network, the invention is not so limited, and includes other communications networks (e.g., a local area network (LAN), a wide area network (WAN), the Internet, a public communication network, etc.). Moreover, while network equipment from different vendors is illustrated as each of base stations 116a, 116b, 116c and power supplies 118a, 118b, and 118c, the invention is not so limited, and includes other types of vendor network equipment (e.g., servers, routers, computer devices, etc.). While various components of FIG. 1 are illustrated as a single component, various of the components described in FIG. 1 can include multiples of the component, and it is contemplated that all such variations fall within the spirit and scope of this disclosure. For example, ML database 108 may be a single database or may include multiple ML model databases (e.g., ML models may be stored in proximity to where they are used and/or may be in additional locations). Network inventory database 110 and network database 114 each may be a single database, or each may include multiple databases. Network control node 106 may include a single node or multiple nodes (e.g., a datacenter that includes a plurality of computers, multiple datacenters such as edge datacenters and radio base stations, etc.). Selector and adaptor node 104 and conversion node 112 each may be located in proximity to or co-located with network control node 106.

Additionally, while various components of network 100d are illustrated as separate components, each of the components described in FIG. 1 can be combined and/or omitted in various combination with each other, and it is contemplated that all such combinations fall within the spirit and scope of this disclosure. For example, selector and adaptor node 104 and conversion node 112 may be combined; ML model database 108 and network control node 106 may be combined in some deployments, e.g., a central deployment such as a datacenter; network inventory database 110 and network database 114 may be combined; selector and adaptor node 104, network control node 106, conversion node 112, ML model database 108 and conversion node 112 may be combined, etc. Further, as described herein, ccomponents 104, 106, 108, 110, 112, and 114 can be virtualized.

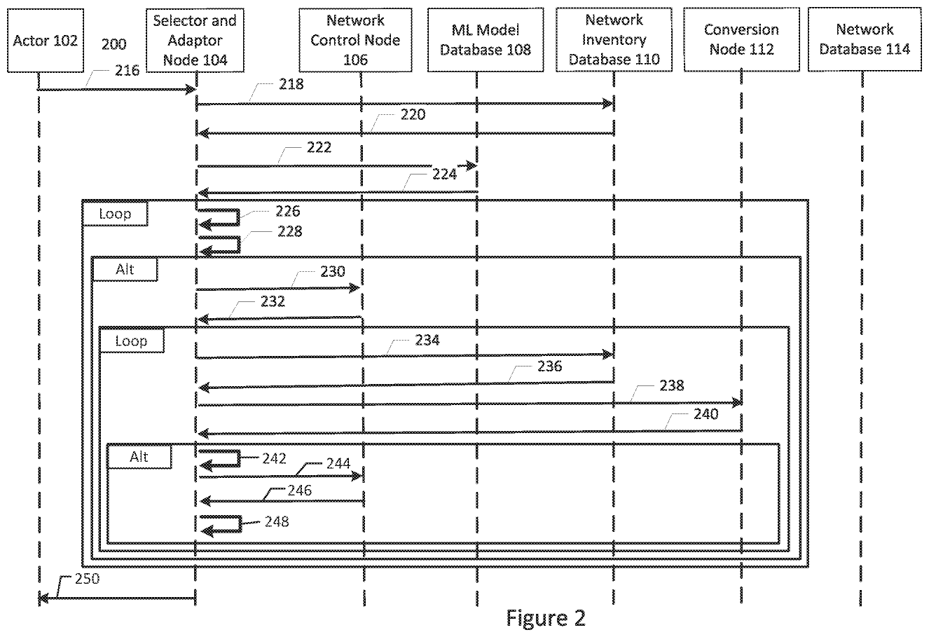

FIG. 2 illustrates an example embodiment of operations 200 that can be performed by a network node (e.g., network node 104) for determining application and reuse of at least one machine learning model from a plurality of machine learning models in a multi-vendor communications network in accordance with some embodiments of the present disclosure.

Referring to FIG. 2, at operation 216, actor device 102 communicates a request to selector and adaptor node 104 operating in a target network 100a to enable running a task for target network 100a on communications network 100 by using a ML model to perform the task. The task may include one of a prediction of a key performance indicator; a proposal for at least one property of target network 100a; a probability for at least one property of target network 100a; an action of target network 100a; an improvement of at least one operating parameter of target network 100a; a classification of data on target network 100a; an analysis of data in target network 100a, etc.

At operation 218, selector and adaptor node 104 requests a description of target network 100a from network inventory database 110. Responsive to the request, at operation 220, network inventory database 110 communicates to selector and adaptor node 104, a network topology and/or network equipment inventory according to an ontology.

At operations 222, selector and adaptor node 104 requests from ML model database 108 an identification of ML models that match a filter based on the requested task (e.g., desired high-level KPI such as KPI degradation). Responsive to the request, at operation 224, ML model database 108 communicates an identification of ML models (e.g., a list of ML models) that match the filter.

At operations 226 and 228, selector and adaptor node 104 iterates through the outputs of each ML model in the filtered identification of ML models to select a ML model(s) that is a match for the requested task (e.g., KPI degradation). For each ML model in the filtered identification, at operation 226, selector and adaptor node 104 selects inputs that apply to target network 100a. At operation 228, selector and adaptor node 104 identifies the ML models from the filtered identification of ML models that include inputs that apply to target network 100a (e.g., matched models).

At operation 230, if selector and adaptor node 104 finds an exact match, selector and adaptor node 104 communicates a request to network control node 106 to deploy the ML model that is an exact match. Responsive to the request, at operation 232, network control node 106, deploys the ML model that is an exact match.

Alternatively, if at operation 230 selector and adaptor node 104 does not find an exact match, at operations 234 -248, selector and adaptor node 104 determines whether a ML model from the matched models can be translated to perform the task or whether no ML model was found to perform the task. At operation 234, selector and adaptor node 104 iterates though the model inputs for the matched models in network inventory database 110 to find inputs/outputs in target network 100a that either match directly or that can be translated to a ML model. Responsive to the iterations, at operation 236, network inventory database 110 provides an identification (e.g., a list) of inputs/outputs and related data to selector and adaptor node 104. At operation 238, selector and adaptor node 104 provides the identification of inputs/outputs and related data to conversion node 112 to search for mapping and/or transformation functions. At operation 240, conversion node 112 provides mapping and/or transformation functions to selector and adaptor node 104.

Responsive to receiving the mapping and/or transformation functions, at operation 242, selector and adaptor node 104 uses the mapping and/or transformation functions to construct a ML model with an adaptor. At operation 244, selector and adaptor node 104 requests that network control node 106 deploy the constructed ML model and adaptor. Responsive to the request, at operation 246, network control node 106 deploys the constructed ML model and adaptor.

Alternatively, at operation 248, selector and adaptor node 104 determines that no ML model was found that can perform the task or that can be translated to perform the task.

At operation 250, selector and adaptor node 104, communicates to actor device 102 that a ML model is ready to perform the requested task or that no ML model was found that can perform the task.

In some embodiments, if there is more than one ML model that can be matched according to the input/output matching, and the datasets for the target network can be converted then the selection of the ML model(s) can be based on the ranking of possible ML model applications. For example, the ranking can be based on historical performance, deployment options, deployment requirements, performance, etc.

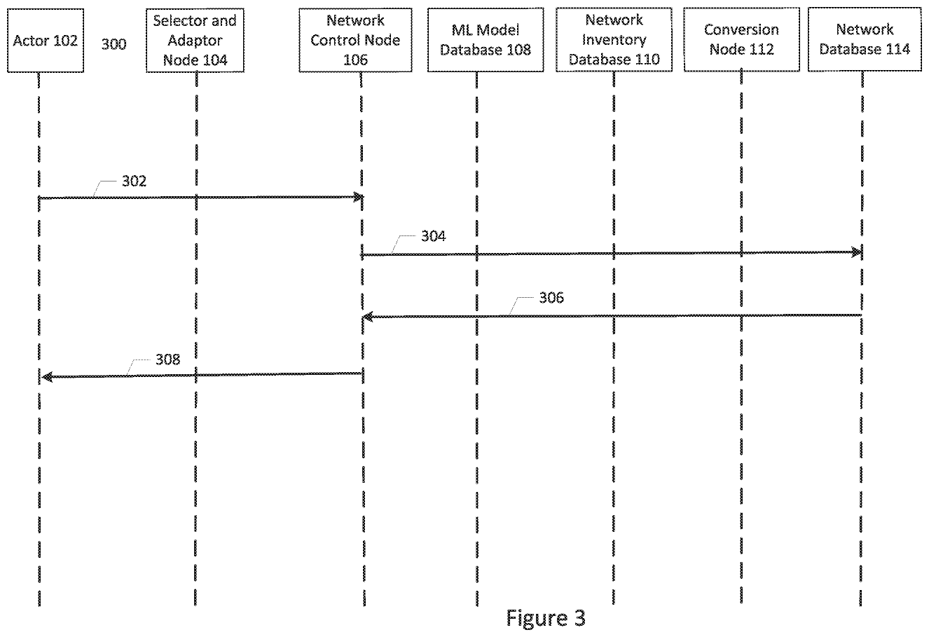

FIG. 3 illustrates an exemplary application 300 of a deployed ML model to perform a task. At operation 302, actor device 102 requests that network control node 106 perform a task using the deployed model (e.g., the deployed model from operation 246). Responsive to the request, at operation 304, network control node 106 makes a read request from network database 114 for data or counters of network 100a needed as input(s) to the deployed ML model. Responsive to the read request, at operation 306, network database 114 provides the requested data or counters to network control node 106; and network control node 106 runs the deployed ML model using the provided data or counters. At operation 308, network control node 106 provides the results from the deployed ML model to actor device 102.

As used herein, actor device 102 is a device capable, configured, arranged and/or operable to communicate wirelessly with network nodes and/or other wireless devices. Unless otherwise noted, the term actor device may be used interchangeably herein with client device or wireless device. Communicating wirelessly may involve transmitting and/or receiving wireless signals using electromagnetic waves, radio waves, infrared waves, and/or other types of signals suitable for conveying information through air. In some embodiments, an actor device may be configured to transmit and/or receive information without direct human interaction. For instance, an actor device may be designed to transmit information to a network on a predetermined schedule, when triggered by an internal or external event, or in response to requests from the radio communication network. Examples of an actor device include, but are not limited to, a smart phone, a mobile phone, a cell phone, a voice over IP (VoIP) phone, a wireless local loop phone, a desktop computer, a personal digital assistant (PDA), a wireless camera, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. An actor device may support device-to-device (D2D) communication, for example by implementing a 3GPP standard for sidelink communication, and may in this case be referred to as a D2D communication device. As yet another specific example, in an Internet of Things (IoT) scenario, an actor device may represent a machine or other device that performs monitoring and/or measurements, and transmits the results of such monitoring and/or measurements to another actor device and/or a network node. The actor device may in this case be a machine-to-machine (M2M) device, which may in a 3GPP context be referred to as a machine-type communication (MTC) device. As one particular example, the actor device may be a user equipment (UE) implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, an actor device may represent a vehicle or other equipment that is capable of monitoring and/or reporting on its operational status or other functions associated with its operation. An actor device as described above may represent the endpoint of a wireless connection, in which case the device may be referred to as a wireless terminal. Furthermore, an actor device as described above may be mobile, in which case it may also be referred to as a mobile device or a mobile terminal.

As used herein, network node (106) refers to equipment capable, configured, arranged and/or operable to communicate directly or indirectly with an actor device and/or with other network nodes or equipment in the communication network to perform functions (e.g., for selecting and adapting a ML model) in the communication network. Examples of network nodes include, but are not limited to, access points (APs) (e.g., radio access points), base stations (BSs) (e.g., radio base stations, Node Bs, evolved Node Bs (eNBs), gNode Bs, etc. Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node. More generally, however, network nodes may represent any suitable device (or group of devices) capable, configured, arranged, and/or operable to provide information regarding availability of ML model for performing a task and/or results from running a deployed ML model to an actor device that has accessed the communication network.

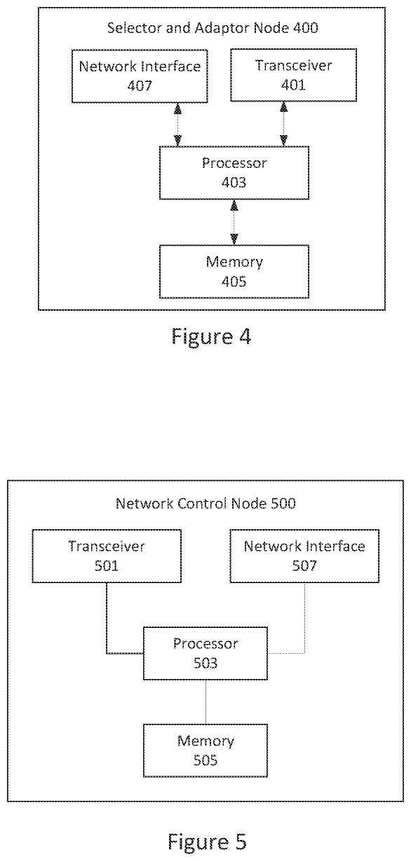

FIG. 4 is a block diagram illustrating a selector and adaptor node 400 according to some embodiments of inventive concepts. A selector and adaptor node 400 may be implemented using the structure of network node 400 from FIG. 4 with instructions stored in device readable medium (also referred to as memory) 405 of network node 400 so that when instructions of memory 405 of network node 400 are executed by at least one processor (also referred to as processing circuitry) 403 of network node 400, at least one processor 403 of network node 403 performs respective operations discussed herein. Processing circuitry 403 of network node 400 may thus transmit and/or receive communications to/from one or more other network nodes/entities/servers of a communication network through network interface 407 of network node 400. In addition, processing circuitry 403 of network node 400 may transmit and/or receive communications to/from one or more wireless devices (e.g., actor device 102 through interface 401 of network node 400 (e.g., using transceiver 401).

FIG. 5 is a block diagram illustrating a network control node 500 according to some embodiments of inventive concepts. A network control node 400 may be implemented using the structure of network node 500 from FIG. 5 with instructions stored in device readable medium (also referred to as memory) 505 of network node 500 so that when instructions of memory 505 of network node 500 are executed by at least one processor (also referred to as processing circuitry) 503 of network node 500, at least one processor 503 of network node 503 performs respective operations discussed herein. Processing circuitry 503 of network node 500 may thus transmit and/or receive communications to/from one or more other network nodes/entities/servers of a communication network through network interface 507 of network node 500. In addition, processing circuitry 503 of network node 500 may transmit and/or receive communications to/from one or more wireless devices (e.g., selector and adaptor node 104 through interface 501 of network node 500 (e.g., using transceiver 501).

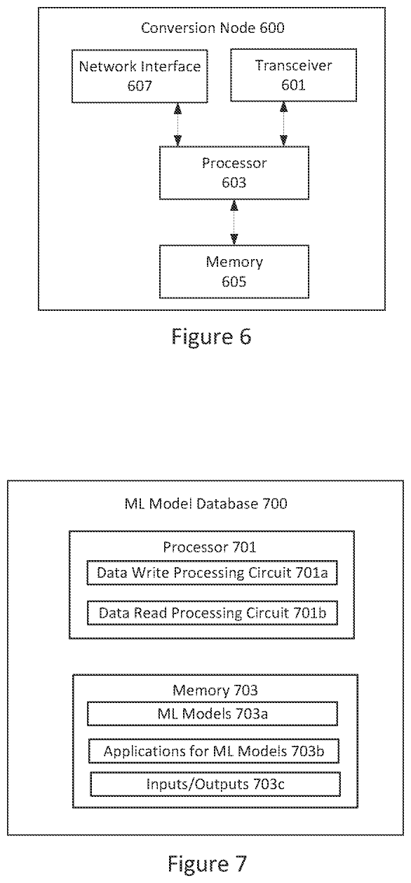

FIG. 6 is a block diagram illustrating a conversion node 600 according to some embodiments of inventive concepts. A conversion node 600 may be implemented using the structure of network node 600 from FIG. 6 with instructions stored in device readable medium (also referred to as memory) 605 of network node 600 so that when instructions of memory 605 of network node 600 are executed by at least one processor (also referred to as processing circuitry) 603 of network node 600, at least one processor 603 of network node 603 performs respective operations discussed herein. Processing circuitry 603 of network node 600 may thus transmit and/or receive communications to/from one or more other network nodes/entities/servers of a communication network through network interface 607 of network node 600. In addition, processing circuitry 603 of network node 600 may transmit and/or receive communications to/from one or more wireless devices (e.g., selector and adaptor node 104 through interface 601 of network node 600 (e.g., using transceiver 601).

FIG. 7 is a block diagram illustrating a ML model database 700 according to some embodiments of inventive concepts. A ML model database 700 may be implemented using the structure of database 700 from FIG. 7. As shown in FIG. 7, database 700 includes an inputs/outputs (I/O) processing unit which may be implemented in the database 700 using at least one processor 701 (also referred to as processing circuitry) and memory 703. The at least one processor 701 includes a data write processing circuit 701a which performs processing relating to writing to database 700, and a data read processing circuit 701b which performs processing relating to reading of data from database 700. Memory 703 further includes storage of ML models 703a, applications for ML models 703b, and inputs and outputs 703c to ML models 703a. The storage of ML models 703a, applications for ML models 703b, and inputs/outputs 703c is provided in device readable media medium (also referred to as memory) 703 of database 700 so that when content and/or instructions of memory 703 of database 700 are executed by at least one processor 701 of database 700, at least one processor 701 of database 700 performs respective operations discussed herein.

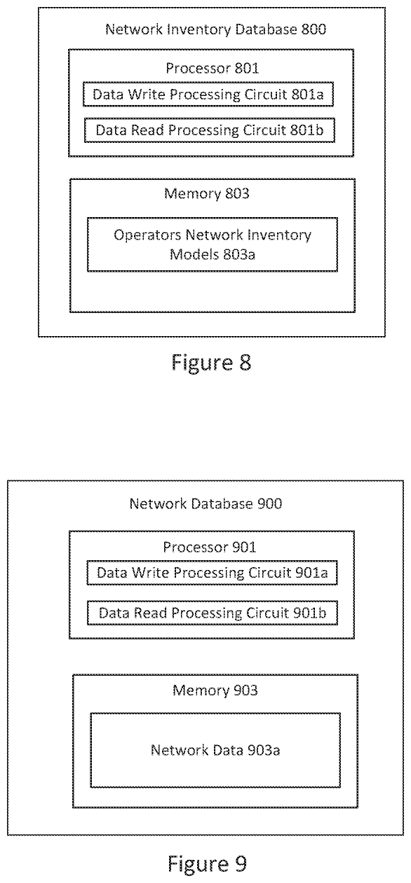

FIG. 8 is a block diagram illustrating a network inventory database 800 according to some embodiments of inventive concepts. A network inventory database 800 may be implemented using the structure of database 800 from FIG. 8. As shown in FIG. 8, database 800 includes an inputs/outputs (I/O) processing unit which may be implemented in the database 800 using at least one processor 801 (also referred to as processing circuitry) and memory 803. The at least one processor 801 includes a data write processing circuit 801a which performs processing relating to writing to database 800, and a data read processing circuit 801b which performs processing relating to reading of data from database 800. Memory 803 further includes storage of operators' network inventory models 803a. The storage of operators' network inventory models 803a is provided in device readable media medium (also referred to as memory) 803 of database 800 so that when content and/or instructions of memory 803 of database 800 are executed by at least one processor 801 of database 800, at least one processor 801 of database 800 performs respective operations discussed herein.

FIG. 9 is a block diagram illustrating a network database 900 according to some embodiments of inventive concepts. A network database 900 may be implemented using the structure of database 900 from FIG. 9. As shown in FIG. 9, database 900 includes an inputs/outputs (I/O) processing unit which may be implemented in the database 900 using at least one processor 901 (also referred to as processing circuitry) and memory 903. The at least one processor 901 includes a data write processing circuit 901a which performs processing relating to writing to database 900, and a data read processing circuit 901b which performs processing relating to reading of data from database 900. Memory 903 further includes storage of network data 903a. The storage of network data 903a is provided in device readable media medium (also referred to as memory) 903 of database 900 so that when content and/or instructions of memory 903 of database 900 are executed by at least one processor 901 of database 900, at least one processor 901 of database 900 performs respective operations discussed herein.

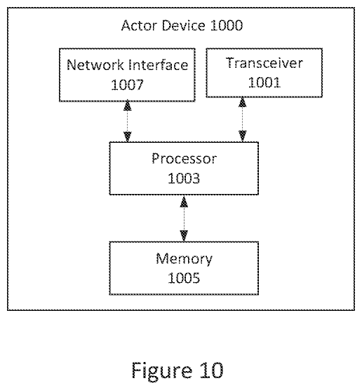

FIG. 10 is a block diagram illustrating an actor device 1000 according to some embodiments of inventive concepts. An actor device 1000 may be implemented using the structure of device 1000 from FIG. 10 with instructions stored in device readable medium (also referred to as memory) 1005 of device 1000 so that when instructions of memory 1005 of device 1000 are executed by at least one processor (also referred to as processing circuitry) 1003 of device 1000, at least one processor 1003 of device 1000 performs respective operations discussed herein. Processing circuitry 1003 of device 1000 may thus transmit and/or receive communications to/from one or more other network nodes/entities/servers of a communication network through network interface 1007 of device 1000. In addition, processing circuitry 1003 of device 1000 may transmit and/or receive communications to/from one or more wireless devices (e.g., selector and adaptor node 104 through interface 1001 of device 1000 (e.g., using transceiver 1001).

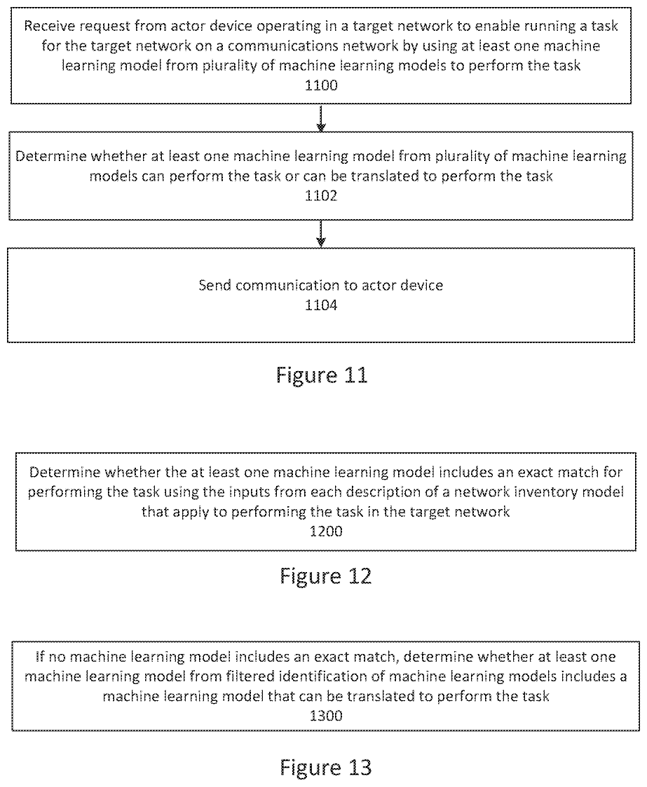

These and other related operations will now be described in the context of the operational flowcharts of FIGS. 11-16 of operations that may be performed by a first network node (e.g., selector and adaptor node 104, 400) according to various embodiments of inventive concepts. Each of the operations described in FIGS. 11-16 can be combined and/or omitted in any combination with each other, and it is contemplated that all such combinations fall within the spirit and scope of this disclosure.

Referring initially to FIG. 11, operations can be performed by a first network node (e.g., selector and adaptor node 104, 400) for determining application of at least one machine learning model from a plurality of machine learning models in a multi-vendor communications network (e.g., 100). The operations of network node 400 include receiving (1100) a request from an actor device (e.g., 102) operating in a target network (e.g., 100a) to enable running a task for the target network (e.g., 100a) on the communications network (e.g., 100) by using at least one of the machine learning models from the plurality of machine learning models to perform the task. The operations of network node 400 further include responsive to the request, determining (1102) whether at least one of the machine learning models from the plurality of machine learning models can perform the task or can be translated to perform the task. The operations of network node 400 further include responsive to the determination, sending (1104) a communication to the actor device (e.g., 102). The communication includes information that a machine learning model from the plurality of machine learning models is ready to perform the task or that no machine learning model was found to perform the task.

In some embodiments, the task includes one of a prediction of a key performance indicator; a proposal for at least one property of the target network; a probability for at least one property of the target network; an action on the target network;

an improvement of at least one operating parameter of the target network; a classification of data in the target network; and an analysis of data in the target network.

In some embodiments, the determining (1102) whether at least one of the machine learning models from the plurality of machine learning models can perform the task or can be translated to perform the task includes obtaining from, a first database (e.g., 110), a network inventory model for each element of inventory of the operator network in the first database. The determining further includes obtaining, from the second database (e.g., 108), a filtered identification of machine learning models from the plurality of machine learning models that can perform the task or that can be translated to perform the task based on filtering the plurality of machine models by the task. The determining further includes selecting at least one machine learning model from the filtered identification of machine learning models based on iterating through each of the filtered identification of machine learning models to identify the at least one machine learning model that includes inputs from each description of a network inventory model that apply to performing the task in the target network.

In some embodiments, the first database (e.g., 110) includes at least one of a network inventory database (e.g., 110); and a network inventory database (e.g., 110) combined with a network database (e.g., 114).

In some embodiments, the second database (e.g., 108) includes at least one of a machine learning model database (e.g., 108); a machine learning model database (e.g., 108) combined with a network control node (106); and a machine learning model database (e.g., 108) combined with a network control node (e.g., 106), the first network node (e.g., 104), and a conversion node (e.g., 112).

In some embodiments, a second database (e.g., 108) includes, for each machine learning model in the database, a purpose of each machine learning model; a description of a network in which each machine learning model is applicable; inputs to each machine learning model; and outputs of each machine learning model.

In some embodiments, the network inventory model for each element of inventory of the operator network in the first database includes a topology of each operator network; an identification of vendor equipment in each operator network; and an identification of configuration for parameters for each vendor equipment in the operator network.

Referring to FIG. 12, further operations that can be performed by a first network node (e.g., 400 in FIG. 4) may include determining (1200) whether the at least one machine learning model includes an exact match for performing the task using the inputs from each description of a network inventory model that apply to performing the task in the target network.

Referring to FIG. 13, further operations that can be performed by a first network node (e.g., 400 in FIG. 4) may include if no machine learning model includes an exact match, determining (1300) whether at least one machine learning model from the filtered identification of machine learning models includes a machine learning model that can be translated to perform the task.

In some embodiments, the determining (1102) whether at least one of the machine learning models from the filtered identification of machine learning models includes a machine learning model that can be translated to perform the task includes communicating a request to the first database (e.g., 110) , for each machine learning model in the filtered identification of machine learning models, to find input data and output data for each operator network that matches or can be translated using a semantic mapping of the input data and the output data across different vendor-specific qualitative or quantitative representations to each machine learning model in the filtered identification of machine learning models. The determining further includes communicating a request to a second network node (e.g., 112) to adapt the input data and the output data based on a conversion function uses the semantic mapping to identify the machine learning models that can be translated to perform the task. The determining further includes, responsive to the request, obtaining from the second network node (e.g., 112) an identification of at least one machine learning model that can be translated to perform the task.

In some embodiments, the first network node and the second network node are included in the same network node.

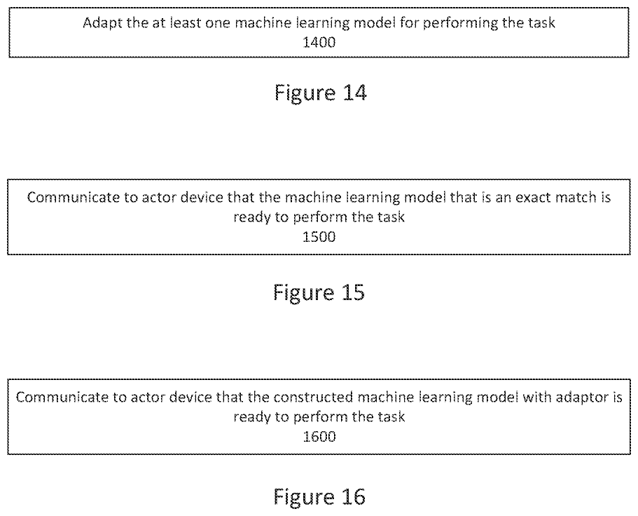

Referring to FIG. 14, further operations that can be performed by a first network node (e.g., 400 in FIG. 4) may include adapting (1400) the at least one machine learning model for performing the task.

In some embodiments, the controlling (1104) deployment of the at least one of the machine learning models from the plurality of machine learning models to perform the task includes, if at least one of the machine learning models is an exact match, initiating deployment of the at least one machine learning model that is an exact match. The controlling further includes, if no machine learning model is an exact match, and there is at least one machine learning model that can be translated to perform the task, initiating deployment of the at least one constructed machine learning model with an adaptor. The controlling further includes, if no machine learning model is an exact match and there is no machine learning model that can be translated to perform the task, communicating to the actor device that no machine learning model was found that can perform the task.

In some embodiments, the initiating deployment of the machine learning model that is the exact match includes communicating a request to a third network node (e.g., 106) to deploy the machine learning model that is an exact match. The initiating deployment further includes, responsive to the communicating the request to the third network node (e.g., 106), receiving a response from the third network node (e.g., 106) indicating the machine learning model that is an exact match is deployed.

In an alternative embodiment, the initiating deployment of the constructed machine learning model with adaptor includes communicating a request to a third network node (e.g., 106) to deploy the constructed machine learning model with adaptor. The initiating deployment further includes, responsive to the communicating the request to the network control node, receiving a response from the third network node (e.g., 106) indicating that the constructed machine learning model with adaptor is deployed.

In some embodiments, the third network node (e.g., 106) further comprises the second database (108).

Referring to FIG. 15, further operations that can be performed by a network node (e.g., 400 in FIG. 4) may include communicating (1500) to the actor device (e.g., 102) that the machine learning model that is an exact match is ready to perform the task.

Referring to FIG. 16, further operations that can be performed by a network node (e.g., 400 in FIG. 4) in an alternative embodiment may include communicating (1600) to the actor device (e.g., 102) that the constructed machine learning model with adaptor is ready to perform the task.

In some embodiments, the determining (1102) whether at least one of the machine learning models from the filtered identification of machine learning models includes a machine learning model that can be translated to perform the task includes identifying a set of machine learning models that can be translated to perform the task, and further includes adapting each machine learning model in the set of machine learning models with an adaptor for performing the task. The determining further includes selecting a machine learning model from the adapted set of machine learning models based on ranking of performance parameters of each machine learning model in the set of machine learning models for the task to be performed for the target network.

In some embodiments, the performance parameters include one of a historical performance; at least one deployment option; at least one deployment requirement; and output performance of each machine learning model in the set of machine learning models.

In some embodiments, the first network node (e.g., 104) further includes the second network node (e.g., 112), the third network node (e.g., 106), and the second database (e.g., 108).

Aspects of the present disclosure have been described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

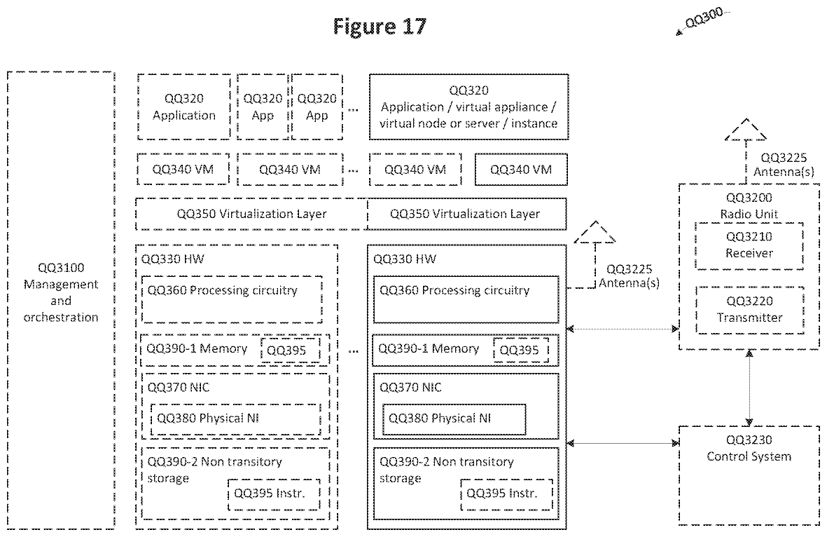

FIG. 17 illustrates a virtualization environment in accordance with some embodiments of the present disclosure.

FIG. 17 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station, a virtualized radio access node, or a virtualized communications network node) or to a device (e.g., an actor device, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node or other communication network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. 17, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. 17.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be affected with the use of control system QQ3230 which may alternatively be used for communication between the hardware nodes QQ330 and radio units QQ3200.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Claims are provided below. Reference numbers/letters are provided in parenthesis by way of example/illustration without limiting example embodiments to particular elements indicated by reference numbers/letters.

1. A method performed by a first network node for determining application of at least one machine learning model from a plurality of machine learning models in a multi-vendor communications network, the method comprising:
receiving a request from an actor device operating in a target network to enable running a task for the target network on the communications network by using at least one of the machine learning models from the plurality of machine learning models to perform the task;
responsive to the request, determining whether at least one of the machine learning models from the plurality of machine learning models can perform the task or can be translated to perform the task; and
responsive to the determination, sending a communication to the actor device, wherein the communication comprises information that a machine learning model from the plurality of machine learning models is ready to perform the task or that no machine learning model was found to perform the task.

2. The method of claim 1, wherein the task comprises one of:
a prediction of a key performance indicator;
a proposal for at least one property of the target network;
a probability for at least one property of the target network;
an action on the target network;
an improvement of at least one operating parameter of the target network;
a classification of data in the target network; and
an analysis of data in the target network.

3. The method of claim 1, wherein the determining whether at least one of the machine learning models from the plurality of machine learning models can perform the task or can be translated to perform the task comprises:
obtaining from, a first database, a network inventory model for each element of inventory of the operator network in the first database;
obtaining, from a second database, a filtered identification of machine learning models from the plurality of machine learning models that can perform the task or that can be translated to perform the task based on filtering the plurality of machine models by the task; and
selecting at least one machine learning model from the filtered identification of machine learning models based on iterating through each of the filtered identification of machine learning models to identify the at least one machine learning model that includes inputs from each description of a network inventory model that apply to performing the task in the target network.

4. The method of claim 3, wherein the first database comprises at least one of:
a network inventory database; and
a network inventory database combined with a network database.

5. The method of claim 3, wherein the second database comprises at least one of:
a machine learning model database;
a machine learning model database combined with a network control node; and
a machine learning model database combined with a network control node, the first network node, and a conversion node.

6. The method of claim 5, wherein the second database comprises, for each machine learning model in the database:
a purpose of each machine learning model;
a description of a network in which each machine learning model is applicable;
inputs to each machine learning model; and
outputs of each machine learning model.

7. The method of claim 4, wherein the network inventory model for each element of inventory of the operator network in the first database comprises:
a topology of each operator network;
an identification of vendor equipment in each operator network; and
an identification of configuration for parameters for each vendor equipment in the operator network.

8. The method of claim 1, further comprising:
determining whether the at least one machine learning model comprises an exact match for performing the task using the inputs from each description of a network inventory model that apply to performing the task in the target network.

9. The method of claim 8, further comprising:
if no machine learning model comprises an exact match, determining whether at least one machine learning model from the filtered identification of machine learning models comprises a machine learning model that can be translated to perform the task.

10. The method of claim 3, wherein the determining whether at least one of the machine learning models from the filtered identification of machine learning models comprises a machine learning model that can be translated to perform the task comprises:
communicating a request to the first database, for each machine learning model in the filtered identification of machine learning models, to find input data and output data for each operator network that matches or can be translated using a semantic mapping of the input data and the output data across different vendor-specific qualitative or quantitative representations to each machine learning model in the filtered identification of machine learning models; communicating a request to a second network node to adapt the input data and the output data based on a conversion function uses the semantic mapping to identify the machine learning models that can be translated to perform the task; and
responsive to the request, obtaining from the second network node an identification of at least one machine learning model that can be translated to perform the task.

11. The method of claim 1, wherein the first network node and the second network node are included in the same network node.

12. The method of claim 1, further comprising:
adapting the at least one machine learning model for performing the task.

13. The method of claim 1, wherein the controlling deployment of the at least one of the machine learning models from the plurality of machine learning models to perform the task comprises:
if at least one of the machine learning models is an exact match, initiating deployment of the at least one machine learning model that is an exact match;
if no machine learning model is an exact match, and there is at least one machine learning model that can be translated to perform the task, initiating deployment of the at least one constructed machine learning model with an adaptor; and
if no machine learning model is an exact match and there is no machine learning model that can be translated to perform the task, communicating to the actor device that no machine learning model was found that can perform the task.

14. The method of claim 13, wherein the initiating deployment of the machine learning model that is the exact match comprises:
communicating a request to a third network node to deploy the machine learning model that is an exact match; and
responsive to the communicating the request to the third network node, receiving a response from the third network node indicating the machine learning model that is an exact match is deployed.

15. The method of claim 13, wherein the initiating deployment of the constructed machine learning model with adaptor comprises:
communicating a request to a third network node to deploy the constructed machine learning model with adaptor; and
responsive to the communicating the request to the third network node, receiving a response from the network control node indicating that the constructed machine learning model with adaptor is deployed.

16. The method of claim 14, wherein the third network node further comprises the second database.

17. The method of claim 12, further comprising:
communicating to the actor device that the machine learning model that is an exact match is ready to perform the task.

18. The method of claim 12, further comprising:
communicating to the actor device that the constructed machine learning model with adaptor is ready to perform the task.

19. The method of claim 1, wherein the determining whether at least one of the machine learning models from the filtered identification of machine learning models comprises a machine learning model that can be translated to perform the task comprises identifying a set of machine learning models that can be translated to perform the task, and further comprising:
adapting each machine learning model in the set of machine learning models with an adaptor for performing the task; and
selecting a machine learning model from the adapted set of machine learning models based on ranking of performance parameters of each machine learning model in the set of machine learning models for the task to be performed for the target network.

20. The method of claim 19, wherein the performance parameters comprise one of:
a historical performance;
at least one deployment option;
at least one deployment requirement; and
output performance of each machine learning model in the set of machine learning models.

21.-25. (canceled)
